(19) United States
(12) Patent Application Publication
(10) Pub. No.: US 2008/0151420 A1
(43) Pub. Date: Jun. 26, 2008

(54) DISK DAMPER APPARATUS, HARD DISK DRIVE APPARATUS WITH THE SAME, AND METHOD OF FABRICATING THE DISK DAMPER APPARATUS

(75) Inventors: Jae-suk LEE, Suwon-si (KR); Sung-wook Kim, Suwonp-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/869,203

(22) Filed: Oct. 9, 2007

(30) Foreign Application Priority Data
Dec. 21, 2006 (KR) 2006-132030

(51) Int. Cl. G11B 33/14

(52) U.S. Cl. 360/97.02

(57) ABSTRACT

A disk damper apparatus and a hard disk drive apparatus (HDD) with the disk damper, and a method of fabricating the disk damper. The disk damper includes a plate interposed between stacked disks and formed of metal and a spacer having a thickness greater than and fabricated separately from the plate to be combined with an outer perimeter of the plate.

### CROSS-REFERENCE TO RELATED APPLICATIONS

This application claims priority under 35 U.S.C. §119(a) from Korean Patent Application No. 10-2006-0132030, filed on Dec. 21, 2006, in the Korean Intellectual Property Office, the disclosure of which is incorporated herein in its entirety by reference.

### BACKGROUND OF THE INVENTION

1. Field of the Invention

The present general inventive concept relates to a hard disk drive apparatus (HDD), and more particularly, to a disk damper apparatus interposed among a plurality of stacked disks, a HDD with the same, and a method of fabricating the disk damper apparatus.

2. Description of the Related Art

A hard disk drive apparatus (HDD) is an example of an auxiliary memory device used in a computer, an MP3 player, a mobile phone, etc. The HDD is an apparatus which records and/or reproduces data on and/or from a data storage medium having a disk shape using a slider with a magnetic head. The HDD includes a disk damper interposed among a plurality of stacked disks. The disk damper inhibits a vibration caused by a high-speed rotation of a disk and has a C shape so as not to disturb a movement of a head stack assembly (HSA) supporting the slide.

A HDD in which three or more disks are stacked increases a data storage capacity. A HDD with a plurality of disks includes a housing having the same size as a housing of a HDD with two or less disks so as to be easily installed in a computer, an MP3 player, etc. Thus, gaps among the disks are smaller in the HDD with the plurality of disks than in the HDD with the two or less disks. Thus, the disk damper must become thinner.

FIG. 1 is a perspective view of a conventional disk damper apparatus adopted in a HDD with three or more disks. Referring to FIG. 1, a disk damper 10 includes a plate 12 interposed among disks and having a C shape and a spacer 14 formed at an outer surface of the plate 12. The spacer 14 is thicker than the plate 12 to maintain gaps among the plates 12 which are stacked.

The plate 12 and the spacer 14 form a single body. The disk damper 10 has a complicated shape. Thus, the disk damper 10 may not be fabricated through pressing or cold forging of metal due to a difference between thicknesses of the plate 12 and the spacer 14. Thus, the disk damper 10 is fabricated through molding of plastic. However, a disk damper formed of a plastic material lacks mechanical hardness. Thus, the disk damper frequently contacts a disk rotating at a high speed during an operation of a HDD. As a result, the disk is damaged by the disk damper.

### SUMMARY OF THE INVENTION

The present general inventive concept provides a disk damper apparatus improved to inhibit a contact with disks adjacent thereto although two or more disk dampers are stacked so as to correspond to three or more stacked disks, a hard disk drive apparatus (HDD) with the disk damper apparatus, and a method of fabricating the disk damper apparatus.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a disk damper apparatus including a plate interposed between a plurality of stacked disks and formed of metal; and a spacer having a thickness greater than and fabricated separately from the plate to be combined with an outer perimeter of the plate .

The foregoing and/or other aspects and utilities of the general inventive concept may also be achieved by providing d a hard disk drive apparatus (HDD) including at least three disks which are stacked to be rotatably spaced apart from one another and at least two disk dampers which are stacked to inhibit vibrations of the at least three disks in a rotational state.

The metal includes one of aluminum and an alloy of aluminum.

The spacer may be formed of metal.

The plate may include plate flanges formed at the outer perimeter of the plate, and the spacer may include spacer flanges corresponding to the plate flanges.

The plate flanges may include combining holes, and the spacer flanges may include combining protrusions which are inserted into and fixed to the combining holes.

The plate flanges and the spacer flanges respectively may include plate screw holes and spacer screw holes through which screws penetrate to combine the plate flanges with the spacer flanges.

The spacer of one of the disk dampers contacts and is combined with the spacer of another disk damper adjacent to the one disk damper in the HDD.

The foregoing and/or other aspects and utilities of the general inventive concept may also be achieved by providing a method of fabricating a disk damper to inhibit a vibration of a disk in a rotational state including fabricating a plate interposed between stacked disks and formed of metal, fabricating a spacer having a thickness greater than the plate; and combining the spacer with an outer perimeter of the plate.

The plate may be formed through pressing or cold forging of metal.

The metal includes one of aluminum and an alloy of aluminum.

The spacer may be formed of metal.

The spacer may be fabricated through pressing or cold forging of metal.

Plate flanges may be formed at the outer perimeter of the plate when the plate is fabricated, spacer flanges may be formed at an outer perimeter of the spacer when the spacer is fabricated, and the spacer flanges may be combined with the plate flanges when the spacer is combined with the plate.

Combining holes may be formed in the plate flanges when the plate is fabricated, combining protrusions may be formed in the spacer flanges when the spacer is fabricated, and the combining protrusions may be inserted into and fixed to the combining holes when the spacer is combined with the plate.

The combining protrusions may be inserted into and fixed to the combining holes through press-fitting or spinning.

Plate screw holes may be formed in the plate flanges when the plate is fabricated, spacer screw holes may be formed in the spacer flanges when the spacer is fabricated, and the spacer flanges may be combined with the plate flanges using screws penetrating the plate screw holes and the spacer screw holes when the spacer is combined with the plate.

The foregoing and/or other aspects and utilities of the general inventive concept may also be achieved by providing a spacer apparatus usable with a disk damper apparatus having a plate, the apparatus including a main body having a spacer exterior surface and a spacer hole, a portion of the spacer exterior surface conforming with a portion of a plate exterior surface of the plate, and a flange extending from the main body and having one of a flange hole and a protrusion, the one of the flange hole and the protrusion aligning with a plate hole of the plate.

The foregoing and/or other aspects and utilities of the general inventive concept may also be achieved by providing a plate apparatus usable with a disk damper apparatus having a spacer, the apparatus including a main body having a plate flange extending therefrom, the plate flange having a plate flange exterior surface and a plate flange hole, a portion of the plate flange exterior surface conforming with a portion of a spacer exterior surface of the spacer, wherein the plate flange hole aligns with one of a spacer hole and a protrusion of the spacer.

The foregoing and/or other aspects and utilities of the general inventive concept may also be achieved by providing a disk damper apparatus, including a plate unit having a main plate body, the main plate body having a plate flange extending therefrom, the plate flange having a plate flange exterior surface and a plate flange hole, a spacer unit having a main spacer body, the main spacer body having a spacer flange extending therefrom, a spacer hole and a spacer exterior surface so that a portion of the spacer exterior surface conforms with a portion of the plate exterior surface, wherein the spacer flange having one of a flange hole and a protrusion aligning with the plate hole.

The foregoing and/or other aspects and utilities of the general inventive concept may also be achieved by providing a hard disk drive apparatus, including a plurality of disks one or more damper units interposed between the plurality of disks, the damper unit having a plate unit and a spacer unit, the plate unit having a main plate body, the main plate body having a plate flange extending therefrom, the plate flange having a plate flange exterior surface and a plate flange hole, the spacer unit having a main spacer body, the main spacer body having a spacer flange extending therefrom, a spacer hole and a spacer exterior surface so that a portion of the spacer exterior surface conforms with a portion of the plate exterior surface, wherein the spacer flange having one of a flange hole and a protrusion aligning with the plate hole.

The foregoing and/or other aspects and utilities of the general inventive concept may also be achieved by providing a disk damper apparatus having a spacer including a plate unit having a plate, a peripheral surface formed around a portion of the plate to correspond to the spacer, and a plate flange extended from the peripheral surface to correspond to a spacer flange extended from the spacer, wherein the peripheral surface comprises a combining surface to receive the spacer, and the plate flange and the spacer flange are coupled to each other using a hole and a protrusion.

The foregoing and/or other aspects and utilities of the general inventive concept may also be achieved by providing a hard disk drive apparatus including a first disk, a second disk disposed over the first disk, a disk damper apparatus disposed between the first disk and the second disk, having a plate unit and a spacer unit formed as separate bodies and connected to each other to be combined in a single body, wherein the plate unit is formed of a first material, and the spacer unit is formed of a second material.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of a conventional disk damper;

FIG. 2 is an exploded perspective view of a hard disk drive apparatus (HDD) according to an embodiment of the present general inventive concept;

FIG. 3 is an exploded perspective view of a plurality of disk dampers of FIG. 2;

FIG. 4 is a perspective view illustrating a method of fabricating a disk damper according to an embodiment of the present general inventive concept; and

FIG. 5 is a perspective view illustrating a method of fabricating a disk damper according to another embodiment of the present general inventive concept.

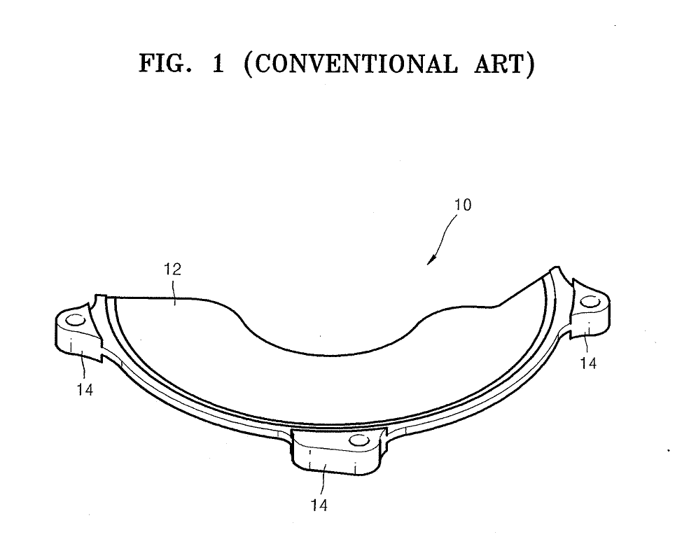

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

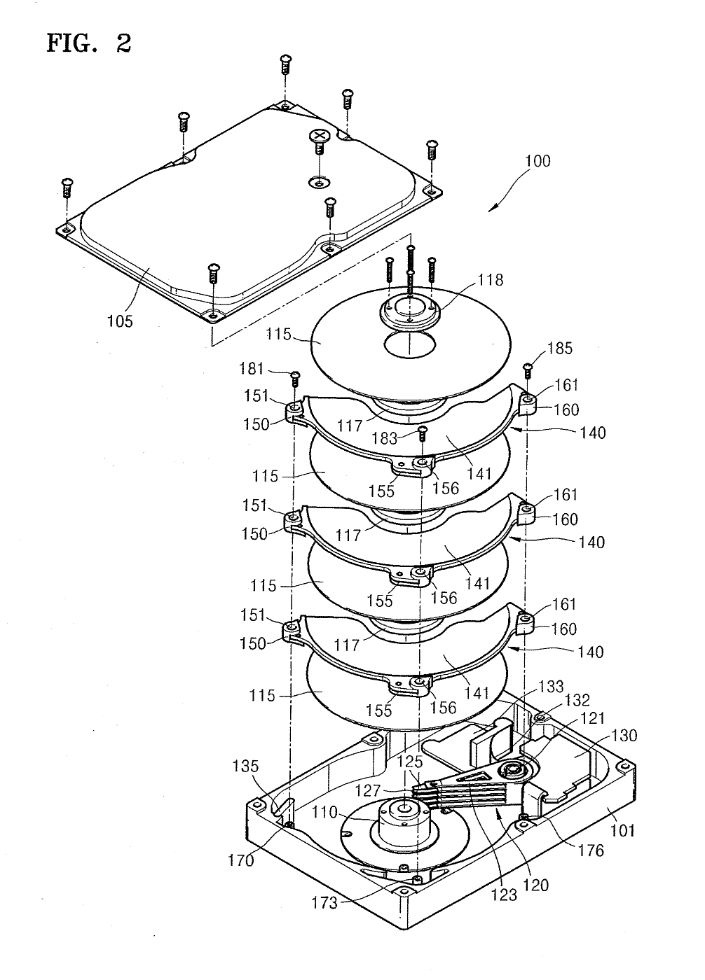

FIG. 2 is an exploded perspective view of a HDD apparatus 100 according to an embodiment of the present general inventive concept. Referring to FIG. 2, the HDD apparatus 100 includes and a housing formed through a combination between a base member 101 and a cover member 105 to have an internal space. The HDD apparatus 100 also includes a spindle motor 110, four disks 115 as data storage media, a head stack assembly (HSA) 120, and a disk damper apparatus of three disk dampers 140 in the housing.

The housing is formed of the base member 101 which supports the spindle motor 110 and the HSA 120 and a cover member 105 which is combined with an upper portion of the base member 110 to cover the disks 115 and the HSA 120. The base member 101 and the cover member 105 are generally formed of stainless or aluminum materials.

The spindle motor 110 rotates the four disks 115 at a high speed and is fixedly installed on the base member 101. The four disks 115 are sequentially put onto the spindle motor 110 to be stacked. Disk spacers 117 are put between the neighboring disks 115 to maintain predetermined gaps among the four disks 115. A disk clamp 118 is combined with an upper end of the spindle motor 110 to rotatably fix the disks 115 onto the spindle motor 110.

The HSA 120 is used to record and/or read data on and/or from the disks 115 and is pivotably installed on the base member 101. The HSA 120 includes a swing arm 123, eight suspensions 125, and eight sliders 127. The swing arm 123 is pivotably combined with a pivot bearing 121. The eight suspensions 125 are combined with a front end of the swing arm 123. The eight sliders 127 are respectively supported by the eight suspensions 125 and face the four disks 115. Magnetic heads (not illustrated) are respectively formed at the eight sliders 127 to record and/or reproduce data.

The HSA 120 pivots in a direction complying with the Fleming's Left-hand Rule due to an interaction between a current input to a voice coil (not illustrated) installed at a back end of the HSA 120 and a magnetic field formed by a magnet (not illustrated) provided at a voice coil motor (VCM) block 130. Thus, the voice coil and the VCM block 130 forms a VCM which pivots the HSA 120. The VCM is controlled by a servo control system.

Referring to FIG. 2, a circulating filter 135 is provided outside the disks 115 to filter foreign elements such as particles contained in air flowing inside the HDD 100. A flexible printed circuit (FPC) bracket 133 is provided at a corner of the base member 101 adjacent to the HSA 120 and connects a FPC 132 connected to the HSA 120 to a main circuit board (not illustrated) disposed underneath the base member 101.

The disk dampers 140 inhibit vibrations of the disks 115 rotating at a high speed and noise caused by the vibrations. Each of the disk dampers 140 are interposed between every two adjacently stacked disks so that three disk dampers 140 are interposed among the four disks 115. Each of the disk dampers 140 includes plates 141 interposed among the stacked disks 115 and first, second, and third spacers 150, 155, and 160 combined with an outer perimeter of each of the plates 141.

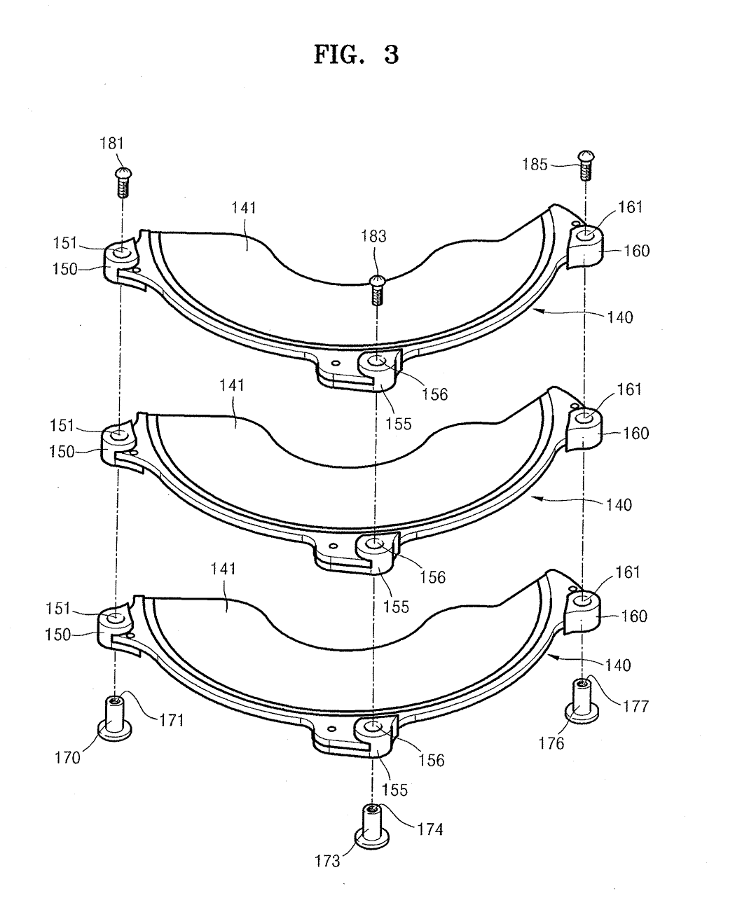

FIG. 3 is an exploded perspective view of the disk dampers 140 of FIG. 2. Referring to FIGS. 2 and 3, the disk dampers 140 are disposed away from the HSA 120 so as not to disturb pivoting of the HSA 120, and the plates have C shapes. The plates 141 have smaller thicknesses than the gaps among the disks 115 so as not to contact the disks 115. Although a HDD includes two or four disks, a housing formed through a combination of a cover member with a base member has a constant thickness. Thus, the plates 141 of the disk dampers 140 installed inside the HDD 100 including the four disks 115 must each have a thinner thickness than a thickness of each of disk dampers installed inside a HDD including two or three disks. In an embodiment of the present general inventive concept, for example, the thinner thickness may be about 1 mm.

The plates 141 may have a mechanical hardness not to be curved by air flowing during high-speed rotations of the disks 115. Thus, in an embodiment of the present general inventive concept, the plates 141 are formed of metal not plastic. The metal may be aluminum or an alloy of aluminum.

The first, second, and third spacers 150, 155, and 160 are fabricated separately from the plates 141 and then combined with the outer perimeters of the plates 141. The first, second, and third spacers 150, 155, and 160 are thicker than the plates 141 so that a gap between the adjacent plates 141 is maintained larger than thicknesses of the disks 115. In an embodiment of the present general inventive concept, the thicknesses of the first, second, and third spacers 150, 155, and 160 are the same.

Referring to FIGS. 2 and 3, the first, second, and third spacers 150, 155, and 160 include first, second, and third connecting holes 151, 156, and 161, respectively, and first, second, and third connecting bosses 170, 173, and 176 are provided on the base member 101 to protrude from the base member 101, so as to install the three disk dampers 140 on the base member 101. First, second, and third screw holes 171, 174, and 177 are formed in the first, second, and third connecting bosses 170, 173, and 176, respectively.

As illustrated in FIG. 3, the three disk dampers 140 are stacked to align and/or connect the first, second, and third connecting holes 151, 156, and 161 of the three disk dampers 140 to one another. The first connecting boss 170 is inserted into the first connecting hole 151, the second connecting boss 173 into the second connecting hole 156, and the third connecting boss 176 into the third connecting hole 161. A first damper fixing screw 181 is inserted into the first screw hole 171, a second damper fixing screw 183 into the second screw hole 174, and a third damper fixing screw 185 into the third screw hole 177. Thus, the three disk dampers 140 may be fixedly installed on the base member 101.

Although the first, second, and third spacers 150, 155, and 160 may be formed of a plastic material, the first, second, and third spacers 150, 155, and 160 may have relatively weak mechanical hardness. Thus, the first, second, and third spacers 150, 155, and 160 may be deformed by screwing of the first, second, and third damper fixing screws 181, 183, and 185. The deformations of the first, second, and third spacers 150, 155, and 160 may result in variations in the gaps among the three plates 141. Thus, contacts between the disks 115 and the plates 140 are increased. Therefore, in an embodiment of the present general inventive concept, the first, second, and third spacers 150, 155, and 160 may be formed of a metal material having stronger mechanical hardness than plastic or may be formed of aluminum or an alloy of aluminum 141.

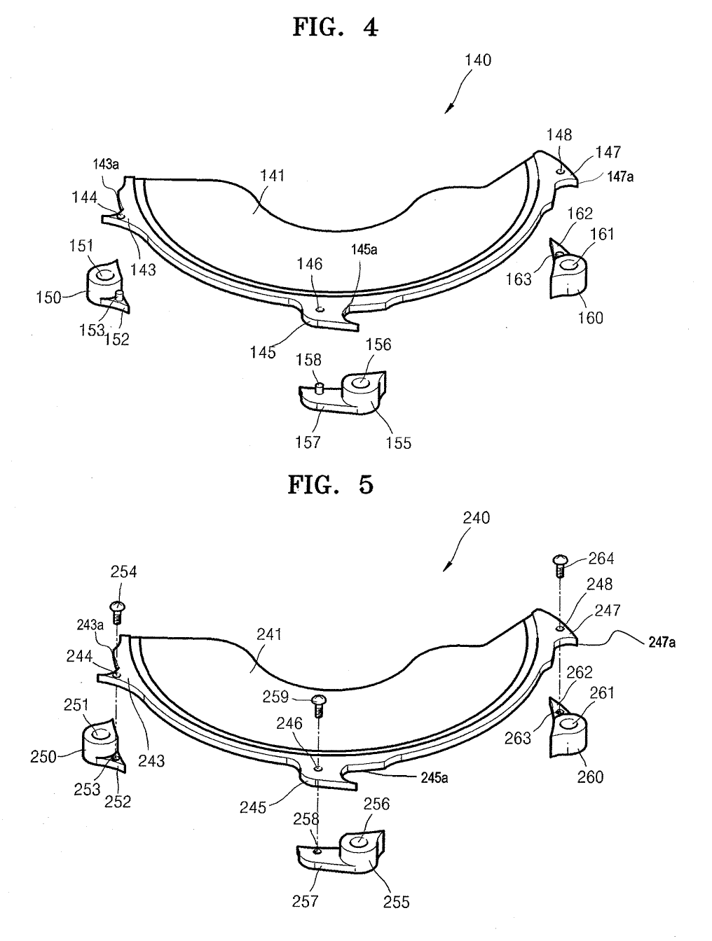

A method of fabricating a disk dampers 140 will now be described with reference to FIGS. 4 and 5.

FIG. 4 is a perspective view illustrating a method of fabricating a disk damper according to an embodiment of the present general inventive concept, and FIG. 5 is a perspective view illustrating a method of fabricating a disk damper according to another embodiment of the present general inventive concept. Referring to FIG. 4, the disk damper 140 includes a plate 140 and first, second, and third spacers 150, 155, and 160. The method of fabricating the disk damper 140 includes: fabricating the plate 141; fabricating the first, second, and third spacers 150, 155, and 160; and combining the first, second, and third spacers 150, 155, and 160 with the plate 141.

The plate 141 has a C shape, i.e., a plane shape having an almost uniform thickness. Thus, metal may be pressed or cold forged to fabricate the plate 141. First, second, and third plate flanges 143, 145, and 147 are formed at an outer perimeter of the plate 141 to be combined with the first, second, and third spacers 150, 155, and 160. First, second, and third combining holes 144, 146, and 148 are formed in the first, and second, and third plate flanges 143, 145, and 147.

If the first, second, and third spacers 150, 155, and 160 are formed of plastic, the first, second, and third spacers 150, 155, and 160 may be fabricated through injection molding of plastic. However, if the first, second, and third spacers 150, 155, and 160 are formed of metal, the metal may be pressed or cold forged to fabricate the first, second, and third spacers 150, 155, and 160 so as to strengthen the mechanical hardness. First, second, and third spacer flanges 152, 157, and 162 are formed at outer perimeters of the first, second, and third spacers 150, 155, and 160 so as to correspond to the first, second, and third plate flanges 143, 145, and 147, respectively. Also, first, second, and third combining protrusions 153, 158, and 163 are formed on the first, second, and third spacer flanges 152, 157, and 162, respectively.

When the first, second, and third spacers 150, 155, and 160 are combined with the plate 141, the first, second, and third combining protrusions 153, 158, and 163 are firmly inserted into the first, second, and third combining holes 144, 146, and 148, respectively. Thus, the first, second, and third plate flanges 143, 145, and 147 are combined with the first, second, and third spacer flanges 152, 157, and 162, respectively. In an embodiment of the present general inventive concept, the first, second, and third combining protrusions 153, 158, and 163 are formed to have diameters slightly greater than inside diameters of the first, second, and third combining holes 144, 146, and 148, the first, second, and third combining protrusions 153, 158, and 163 may be press-fit into the first, second, and third combining holes 144, 146, and 148 or ends of the first, second, and third combining protrusions 153, 158, and 163 inserted into the first, second, and third combining holes 144, 146, and 148 may be spun. Thus, the first, second, and third combining protrusions 153, 158, and 163 may be fixed into the first, second, and third combining holes 144, 146, and 148.

In an embodiment of the present general inventive concept, a disk damper 240 of FIG. 5 may be included in the HDD 100 of FIG. 2 instead of the disk damper 140 of FIG. 2. Referring to FIG. 5, the disk damper 240 includes a plate 241 and first, second, and third spacers 250, 255, and 260. In an embodiment of the present general inventive concept, the plate 241 may be fabricated separately from the first, second, and third spacers 250, 255, and 260. The method of fabricating the disk damper 240 also includes: fabricating the plate 241; fabricating the first, second, and third spacers 250, 255, and 260, and combining the plate 241 with the first, second, and third spacers 250, 255, and 260.

The plate 241 has a C shape, i.e., a plane shape having an almost uniform thickness. Thus, metal may be pressed or cold forged to fabricate the plate 241. First, second, and third plate flanges 243, 245, and 247 are formed at an outer perimeter of the plate 241 to be combined with the first, second, and third spacers 250, 255, and 260. First, second, and third plate screw holes 244, 246, and 248 are formed in the first, second, and third plate flanges 243, 245, and 247.

If the first, second, and third spacers 250, 255, and 260 are formed of plastic, the first, second, and third spacers 250, 255, and 260 may be fabricated through injection molding of the plastic. However, if the first, second, and third spacers 250, 255, and 260 are formed of metal, the first, second, and third spacers 250, 255, and 260 may be fabricated through pressing or cold forging of the metal. First, second, and third spacer flanges 252, 257, and 262 are formed at outer perimeters of the first, second, and third spacers 250, 255, and 260 so as to correspond to the first, second, and third plate flanges 243, 245, and 247. First, second, and third spacer screw holes 253, 258, and 263 are formed in the first, second, and third spacer flanges 252, 257, and 262.

When the plate 241 is combined with the first, second, and third spacers 250, 255, and 260, the first, second, and third spacer flanges 252, 257, and 262 overlap with the first, second, and third plate flanges 243, 245, and 247 so that the first, second, and third screw holes 253, 258, and 263 of the first, second, and third spacers 250, 255, and 260 are aligned and/or connected to the first, second, and third screw holes 244, 246, 248 of the plate 241. The first, second, and third spacer screw holes 253, 258, and 263 are combined with the first, second, and third plate screw holes 244, 246, and 248 using first, second, and third spacer combining screws 254, 259, and 264. Thus, the first, second, and third spacers 250, 255, and 260 are combined with the outer perimeter of the plate 241.

As described above, a disk damper apparatus according to various embodiments of the present general inventive concept can include a plate formed of metal. Thus, the disk damper apparatus can be thin and have high mechanical hardness. Thus, the disk damper can be inhibited from contacting a disk during an operation of a HDD. As a result, the disk can be prevented from being damaged. Also, the disk damper can be applied to a HDD with three or more stacked disks.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A disk damper apparatus to inhibit a vibration of a disk in a rotational state, the apparatus comprising:
a plate interposed between stacked disks and formed of metal; and
a spacer having a thickness greater than and fabricated separately from the plate to be combined with an outer perimeter of the plate.

2. The apparatus of claim 1, wherein the metal comprises one of aluminum and an alloy of aluminum.

3. The apparatus of claim 1, wherein the spacer is formed of metal.

4. The apparatus of claim 1, wherein the plate comprises plate flanges formed at the outer perimeter of the plate, and the spacer comprises spacer flanges corresponding to the plate flanges.

5. The apparatus of claim 4, wherein the plate flanges comprise combining holes, and the spacer flanges comprise combining protrusions which are inserted into and fixed to the combining holes.

6. The apparatus of claim 4, wherein the plate flanges and the spacer flanges respectively comprise plate screw holes and spacer screw holes through which screws penetrate to combine the plate flanges with the spacer flanges.

7. A hard disk drive apparatus (HDD)) comprising at least three disks which are stacked to be rotatably spaced apart form one another and at least two disk dampers which are stacked to inhibit vibrations of the at least three disks in a rotational state,
wherein the disk damper comprises:
plates interposed among the at least three disks and formed of metal; and
spacers having a thickness greater than and fabricated separately from the plates to be combined with outer perimeters of the plates.

8. The HDD of claim 7, wherein the metal comprises one of aluminum and an alloy of aluminum.

9. The HDD of claim 7, wherein the spacers are formed of metal.

10. The HDD of claim 7, wherein the plates comprise plate flanges formed at the perimeters of the plates, and the spacers comprise spacer flanges corresponding to the plate flanges.

11. The HDD of claim 10, wherein the plate flanges comprise combining holes, and the spacer flanges comprise combining protrusions which are inserted into and fixed to the combining holes.

12. The HDD of claim 10, wherein the plate flanges and the spacer flanges respectively comprise plate screw holes and spacer screw holes through which screws penetrate to combine the plate flanges with the spacer flanges.

13. The HDD of claim 7, wherein the spacer of one of the disk dampers contacts and is combined with the spacer of another disk damper adjacent to the one disk damper.

14. A method of fabricating a disk damper to inhibit a vibration of a disk in a rotational state, the method comprising:
fabricating a plate interposed between stacked disks and formed of metal;
fabricating a spacer having a thickness greater than the plate; and
combining the spacer with an outer perimeter of the plate.

15. The method of claim 14, wherein the plate is formed through pressing or cold forging of metal.

16. The method of claim 14, wherein the metal comprises one of aluminum and an alloy of aluminum.

17. The method of claim 14, wherein the spacer is formed of metal.

18. The method of claim 17, wherein the spacer is fabricated through pressing or cold forging of metal.

19. The method of claim 14, wherein plate flanges are formed at the outer perimeter of the plate when the plate is fabricated, spacer flanges are formed at an outer perimeter of the spacer when the spacer is fabricated, and the spacer flanges are combined with the plate flanges when the spacer is combined with the plate.

20. The method of claim 19, wherein combining holes are formed in the plate flanges when the plate is fabricated, combining protrusions are formed in the spacer flanges when the spacer is fabricated, and the combining protrusions are inserted into and fixed to the combining holes when the spacer is combined with the plate.

21. The method of claim 20, wherein the combining protrusions are inserted into and fixed to the combining holes through press-fitting or spinning.

22. The method of claim 19, wherein plate screw holes are formed in the plate flanges when the plate is fabricated, spacer screw holes are formed in the spacer flanges when the spacer is fabricated, and the spacer flanges are combined with the plate flanges using screws penetrating the plate screw holes and the spacer screw holes when the spacer is combined with the plate.

23. A spacer apparatus usable with a disk damper apparatus having a plate, the apparatus comprising:
a main body having a spacer exterior surface and a spacer hole, a portion of the spacer exterior surface conforming with a portion of a plate exterior surface of the plate; and
a flange extending from the main body and having one of a flange hole and a protrusion, the one of the flange hole and the protrusion aligning with a plate hole of the plate.

24. The apparatus of claim 23, wherein a thickness of the main body of the spacer apparatus is greater than a thickness of the plate.

25. A plate apparatus usable with a disk damper apparatus having a spacer, the apparatus comprising:
a main body having a plate flange extending therefrom, the plate flange having a plate flange exterior surface and a plate flange hole, a portion of the plate flange exterior surface conforming with a portion of a spacer exterior surface of the spacer;
wherein the plate flange hole aligns with one of a spacer hole and a protrusion of the spacer.
